(19) United States
(12) Patent Application Publication
(10) Pub. No.: US 2008/0159465 A1
(43) Pub. Date: Jul. 3, 2008

(54) FAST REACTOR

(75) Inventors: Takanari Inatomi, Kawasaki-Shi (JP); Toshiyuki Suzuki, Tokyo (JP); Hiroshi Nakamura, Hadano-Shi (JP); Kenjiro Fukamichi, Kanagawa-Ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/934,449

(22) Filed: Nov. 2, 2007

(30) Foreign Application Priority Data
Nov. 13, 2006 (JP) 2006-306809

(51) Int. Cl. G21C 1/02

(52) U.S. Cl. 376/348

(57) ABSTRACT

To provide a fast reactor having improved structural reliability and excellent safety. A fast reactor 1 comprises: a reactor vessel 7 accommodating therein a reactor core 2 and a primary coolant 5; an intermediate heat exchanger 15 disposed in the reactor vessel 7, for transferring a heat energy of the primary coolant 5 heated in the reactor core 2 to a secondary coolant 45; an intermediate heat exchanger upper drum 15a disposed above the intermediate heat exchanger 15. Disposed above the intermediate heat exchanger upper drum 15a is an upper plug 10 having a neutron shielding function and a heat shielding function. A thermal-expansion absorbing unit 46 is disposed between the intermediate heat exchanger upper drum and the upper plug, for absorbing a thermal expansion of the intermediate heat exchanger upper drum in an axial direction and a radial direction of the intermediate heat exchanger upper drum, and defining a reactor cover gas boundary.

### CROSS REFERENCE TO RELATED APPLICATIONS

This application claims a priority of JP Patent Application No. 2006-306809 filed on Nov. 13, 2006, and the entire contents of which are incorporated herein by reference.

### FIELD OF THE INVENTION

The present invention relates to a fast reactor having improved structural reliability and excellent safety.

### BACKGROUND ART

FIG. 5 shows an example of a conventional fast reactor disclosed in the Patent Document 1. A fast reactor 1 includes a reactor vessel 7, and a reactor core 2 disposed in the reactor vessel 7. The reactor core 2 is made of a nuclear fuel assembly, and has generally a cylindrical shape. An outer circumference of the reactor core 2 is surrounded by a core barrel 3 that protects the reactor core 2. A reflector 4 is disposed outside the core barrel 3. The reflector 4 is connected via a drive shaft 11 to a reflector driving apparatus 12 that is placed above an upper plug 10. The reflector 4 is vertically moved around the reactor core 2 by the driving of the reflector driving apparatus 12 so as to control a reactivity of the reactor core 2. Placed outside the reflector 4 is a partition wall 6 that surrounds the reflector 4 and serves as an inner wall of a channel of a primary coolant 5. The channel of the primary coolant 5 is formed in a space between the partition wall 6 and the reactor vessel 7. A neutron shielding member 8 is disposed in the channel of the primary coolant 5 to surround the reactor core 2. In addition, a guard vessel 9 is disposed to surround an outer circumference of the reactor vessel 7. The reactor core 2, the core barrel 3, the partition wall 6, and the neutron shielding member 8 are mounted on and supported by a reactor-core supporting plate 13.

In an annular space above the neutron shielding member 8, there is disposed an intermediate heat exchanger 15 capable of being taken out from the reactor vessel 7. An intermediate heat exchanger upper drum 15a is disposed above the intermediate heat exchanger 15, and a decay-heat removing coil 16 is disposed inside the intermediate heat exchanger upper drum 15a. An solenoid pump 14 is disposed below the intermediate heat exchanger 15, and a seal bellows 17 is disposed on an upper end of the partition wall 6. Disposed above the intermediate heat exchanger upper drum 15a is the upper plug 10. The upper plug 10 is connected to the intermediate heat exchanger 15 via the intermediate heat exchanger upper drum 15a. A cover gas boundary 34 is formed by the upper plug 10 and the intermediate heat exchanger upper drum 15a. A space formed by the upper plug 10, the intermediate heat exchanger upper drum 15a, and a primary coolant liquid surface 5a is filled with a cover gas 33 of argon gas.

Disposed above the intermediate heat exchanger 15 are an inlet nozzle 18 for introducing a secondary coolant 45 into the intermediate heat exchanger 15, and an outlet nozzle 19 through which the secondary coolant 45 from the intermediate heat exchanger 15 passes. An outer shroud 23 is disposed inside the reactor vessel 7, and an inner drum 20 and an outer drum 21 are disposed inside the outer shroud 23. A heat-transfer pipe 22 is disposed between the inner drum 20 and the outer drum 21.

[Patent Document 1] JP6-174882A

[Patent Document 2] JP8-62371A

### DISCLOSURE OF THE INVENTION

In general, the primary coolant 5 is used in the fast reactor 5 at a temperature between 350° C. and 500° C. Namely, in a cold region from the intermediate heat exchanger 15 to an inlet of the reactor core 2, a temperature of the primary coolant 5 is 350° C., while in a hot region from an outlet of the reactor core 2 to an inlet of the intermediate heat exchanger 15, a temperature of the primary coolant 5 is 500° C. Thus, the structural elements in the fast reactor 1 are used at a high temperature as well as with a wide range of temperature.

For example, a temperature of a lower surface 10b of the upper plug 10 reaches 500° C. Placed on an upper surface 10a of the upper plug 10 are the reactor driving apparatus 12 and other reactor instrumentation equipments. In order to secure soundness of the reflector driving apparatus 12 and the like, a temperature of an atmosphere around the reflector driving apparatus 12 and the like has to be kept at not more than 60° C. Thus, a temperature of the upper surface 10a of the upper plug 10 has to be lowered to about 100° C. In order therefor, the upper plug 10 has not only a neutron shielding function, but also a heat shielding function.

Since the upper plug 10 is classified as a hot plug, the upper plug 10 has some problems peculiar to the hot plug. The most serious problem is a thermal stress. As described above, there is a temperature difference of up to 400° C. between the upper part of the upper plug 10 (100° C.) and the intermediate heat exchanger 15 (500° C.). Thus, there is a significantly large thermal expansion difference of the intermediate exchanger upper drum 15a in a radial direction. When the upper plug 10 and the intermediate heat exchanger upper drum 15a are directly connected to each other, which is the case as described above, the intermediate heat exchanger upper drum 15a cannot freely, thermally expand in the radial direction. As a result, the structural elements such as the intermediate heat exchanger upper drum 15 and so on undergo an excessive thermal stress. In particular, an area of the cover gas boundary 34 is exposed to a very severe environment, since the area is subject not only to the temperature difference but also to a pressure difference.

When the upper plug 10 is disposed above the intermediate heat exchanger 15, which is the case as described above, a temperature of the intermediate heat exchanger upper drum 15a reaches 500° C. Since the intermediate heat exchanger 15 and the intermediate heat exchanger upper drum 15a are of a vertically long structure, a large thermal expansion is generated also in the vertical direction. Thus, there is a possibility that a height position of the reflector driving apparatus 12, which controls a reactivity of the reactor core 2 by vertically driving the reflector 4, is changed depending on various operation conditions of the fast reactor 1, such as activation, operation, and shutdown. This phenomenon is fairly serious in the view point of output control of a reactor core and safety of the reactor core 1.

The present invention has been made in view of the above circumstances. The object of the present invention is to provide a fast reactor having improved structural reliability and excellent safety.

### Means for Solving the Problem

The present invention is a fast reactor comprising: a reactor vessel accommodating therein a reactor core and a primary coolant; an intermediate heat exchanger disposed in the reactor vessel, for transferring a heat energy of the primary coolant heated in the reactor core to a secondary coolant; an intermediate heat exchanger upper drum disposed above the intermediate heat exchanger; an upper plug disposed above the intermediate heat exchanger upper drum, and having a neutron shielding function and a heat shielding function; and a thermal-expansion absorbing unit disposed between the intermediate heat exchanger upper drum and the upper plug, for absorbing a thermal expansion of the intermediate heat exchanger upper drum in an axial direction and a radial direction of the intermediate heat exchanger upper drum, and defining a reactor cover gas boundary.

The present invention is a fast reactor wherein a convection preventing unit is disposed between the upper plug and the U-shaped cross section drum, for restraining movement of heat caused by convection of a cover gas.

The present invention is a fast reactor wherein an inside of the U-shaped cross section drum is filled with a heat insulating member.

The present invention is a fast reactor wherein one of the upper plug, the intermediate heat exchanger upper drum, and the U-shaped cross section drum has a coolant vapor removing unit for preventing vapor of the primary coolant from flowing outward from a gap formed by the upper plug, the intermediate heat exchanger upper drum, and the U-shaped cross section drum.

The present invention is a fast reactor wherein a radiation and convection preventing plate is attached to a lower surface of the upper plug, and the radiation and convection preventing plate restrains radiation and convection of heat in a space formed by the upper plug, the intermediate heat exchanger upper drum, and a primary coolant liquid surface.

According to the present invention, since the thermal-expansion absorbing unit absorbs a thermal expansion of the intermediate heat exchanger upper drum in the axial direction and in the radial direction, no excessive load is applied to the structural elements such as the intermediate heat exchanger upper drum 15a or the like. Thus, a structural reliability of the fast reactor can be improved, and a safety thereof can be made excellent.

According to the present invention, since the upper plug is secured on the reactor pedestal via the upper-plug supporting unit that directly supports a weight of the upper plug, variation of a height position of the upper plug can be restrained upon change of operation conditions of the fast reactor. Thus, it can be prevented that a height position of the reflector driving apparatus placed on the upper surface of the upper plug is displaced to give an impact on an output of the fast reactor.

Further, according to the present invention, since the thermal-expansion absorbing unit includes a U-shaped cross section drum that is attached to the intermediate heat exchanger upper drum and has a U-shaped cross section, a thermal expansion of the intermediate heat exchanger upper drum in the radial direction can be absorbed. Thus, a structural reliability of the fast reactor can be improved, and a safety thereof can be made excellent.

Furthermore, according to the present invention, since the thermal-expansion absorbing unit includes a bellows that is attached to the upper plug to absorb a thermal expansion of the intermediate heat exchanger upper drum in the axial direction can be absorbed, it can be prevented that a height position of the reflector driving apparatus is displaced to give an impact on an output of the fast reactor. Thus, a structural reliability of the fast reactor can be improved, and a safety thereof can be made excellent.

Furthermore, according to the present invention, since a convection preventing unit is disposed between the upper plug and the U-shaped cross section drum, it is possible to restrain movement of heat toward bellows caused by convection of the cover gas, whereby a temperature of the bellows can be lowered.

Furthermore, according to the present invention, since an inside of the U-shaped cross section drum is filled with a heat-insulating member, it is possible to restrain movement of heat toward the bellows caused by conduction of heat, whereby a temperature of the bellows can be lowered.

Furthermore, according to the present invention, since there is disposed a coolant vapor removing unit for preventing vapor of the primary coolant from flowing outside from a gap formed by the upper plug, the intermediate heat exchanger upper drum, and the U-shaped cross section drum, it can be prevented that a temperature of the gap is lowered after the vapor of the primary coolant comes thereinto, so that the primary coolant is solidified. Thus, it can be prevented that the upper plug and the intermediate heat exchanger upper drum or the U-shaped cross section drum are adhered to each other, making impossible disassembly.

Furthermore, according to the present invention, since a radiation and convection preventing plate is attached to a lower surface of the upper plug, it is possible to radiation and convection of heat in a space formed by the upper plug, the intermediate heat exchanger upper drum, and a primary coolant liquid surface, whereby natural convection in a cover gas and direct radiation from the primary coolant liquid surface to the upper plug can be restrained. Thus, heat input to the upper plug can be reduced.

### BRIEF DESCRIPTION OF THE DRAWINGS

FIG. 1 is a vertical sectional view of a first embodiment of a fast reactor according to the present invention;

FIG. 2 is an enlarged view of an area around an upper plug;

FIG. 3 is an enlarged view of (A) part in FIG. 2;

FIG. 4 is a vertical sectional view of a second embodiment of a fast reactor according to the present invention; and

FIG. 5 is a vertical sectional view of a conventional fast reactor.

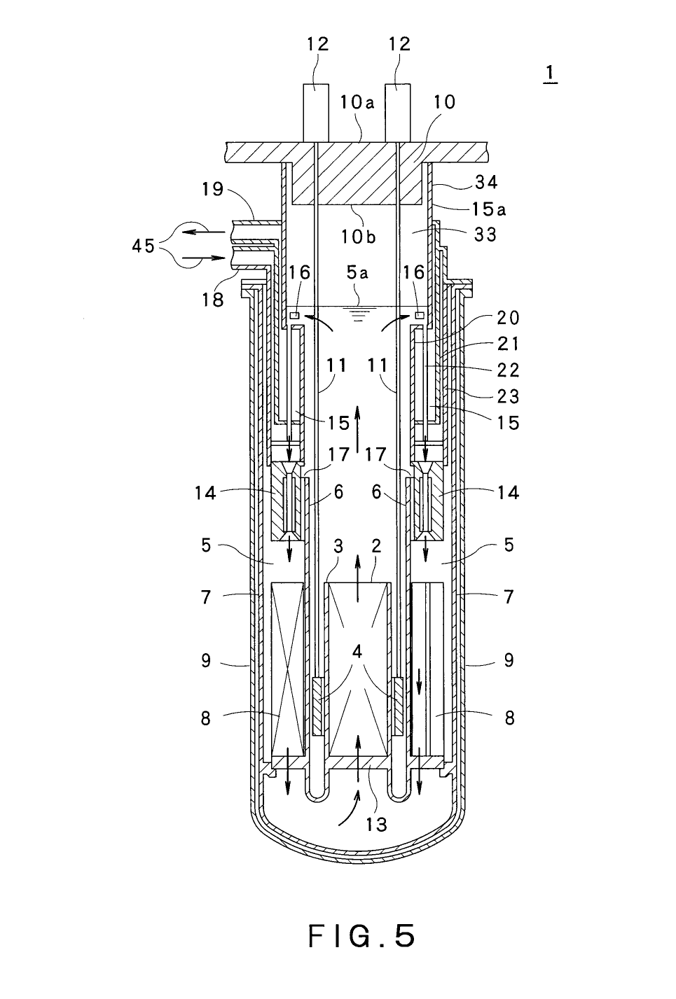

### BEST MODE FOR CARRYING OUT THE INVENTION

### First Embodiment

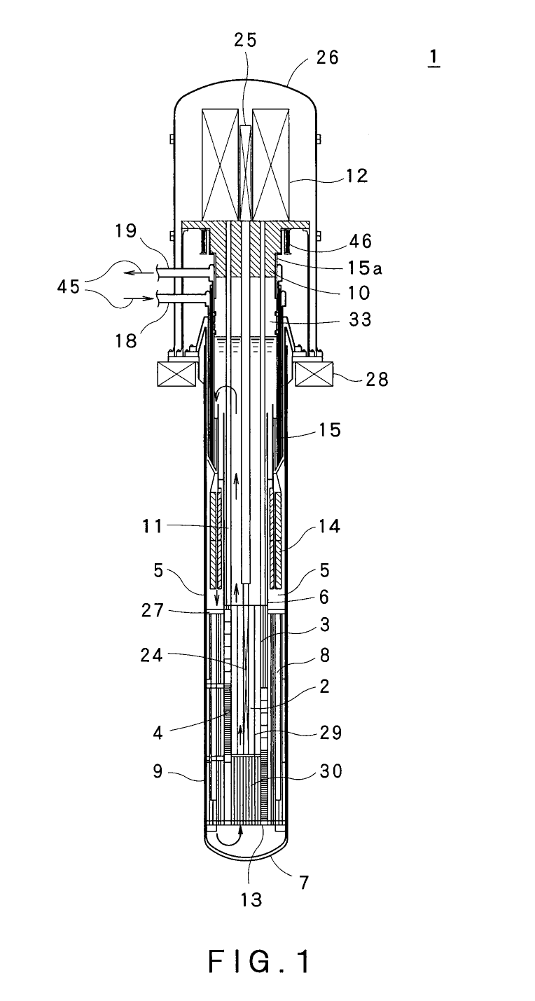

A first embodiment of the present invention is described below with reference to FIGS. 1 to 3.

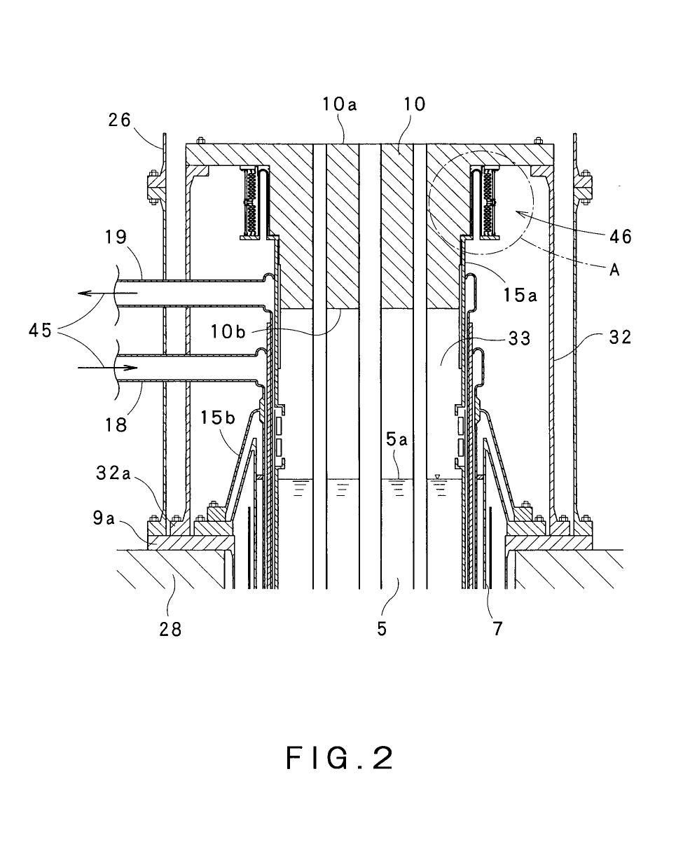

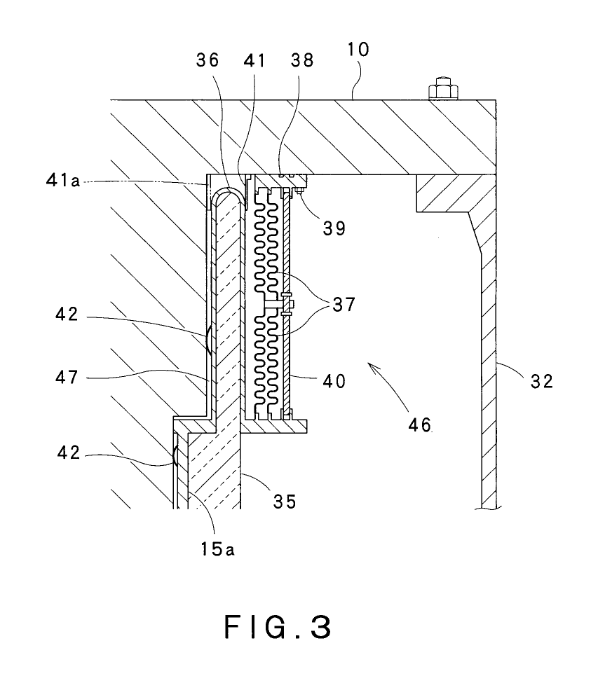

FIG. 1 is a vertical sectional view of a first embodiment of a fast reactor according to the present invention. FIG. 2 is an enlarged view of an area around an upper plug. FIG. 3 is an enlarged view of (A) part in FIG. 2.

A general structure of a fast reactor in this embodiment is described with reference to FIGS. 1 to 3.

As shown in FIGS. 1 and 2, a fast reactor 1 includes: a reactor vessel 7 accommodating therein a reactor core 2 made of a nuclear fuel assembly containing plutonium, and a primary coolant 5 made of liquid sodium; an intermediate heat exchanger 15 disposed in the reactor vessel 7, for transferring a heat energy of the primary coolant 5 heated in the reactor core 2 to a secondary coolant 45; and an intermediate heat exchanger upper drum 15a disposed above the intermediate heat exchanger 15.

A fuel assembly 29 containing the reactor core 2 is mounted on an entrance module 30 which is mounted on a reactor-core supporting plate 13. An outer circumference of the reactor core 2 is surrounded by a core barrel 3 that protects the reactor core 2. A reflector 4 is disposed outside the core barrel 3. The reflector 4 is connected via a drive shaft 11 to a reflector driving apparatus 12 that is placed above an upper plug 10. The reflector 4 is vertically moved around the reactor core 2 by the driving of the reflector driving apparatus 12 so as to control a reactivity of the reactor core 2. Placed outside the reflector 4 is a partition wall 6 that surrounds the reflector 4 and serves as an inner wall of a channel of a primary coolant 5. The reactor vessel 7 serving as an outer wall of the channel of the primary coolant 5 is disposed outside the partition wall 6 to be spaced apart therefrom. A guard vessel 9 is disposed to surround an outer circumference of the reactor vessel 7. A neutron shielding member 8 is disposed in the channel of the primary coolant 5 to surround the reactor core 2. An upper supporting plate 27 is fitted in the reactor vessel 7, for supporting the core barrel 3, partition wall 6, and the neutron shielding member 8.

The intermediate heat exchanger 15 is disposed in an annular space above the upper supporting plate 27. The intermediate heat exchanger 15 is secured on a reactor pedestal 28 via an intermediate heat exchanger skirt 15b. The intermediate heat exchanger 15 can be taken out from the reactor vessel 7. A solenoid pump 14 is disposed below the intermediate heat exchanger 15, and a decay-heat removing coil 16 is disposed inside the intermediate heat exchanger upper drum 15a.

Disposed near the reactor core 2 is a reactor shutdown rod 24 that is driven by a reactor shutdown rod driving apparatus 25 which is placed above the upper plug 10. The reactor core rod driving apparatus 25 and the reflector driving apparatus 12 are surrounded by a containment dome 26 secured on the reactor pedestal 28.

Placed above the intermediate heat exchanger upper drum 15a is the upper plug 10 as a hot plug having a neutron shielding function and a heat shielding function. As shown in FIG. 2, the upper plug 10 is secured on the reactor pedestal 28 via an upper-plug supporting unit (upper-plug supporting table) 32 that directly supports a weight of the upper plug 10. Namely, a lower flange 32a of the upper-plug supporting table 32 is fastened on a guard vessel upper flange 9a. Thus, a load of the upper plug 10 is not directly loaded on the intermediate heat exchanger 15, but is transferred to the reactor pedestal 28 via the lower flange 32a of the upper-plug supporting table 32 and the guard vessel upper flange 9a. A space formed by the upper plug 10, the intermediate heat exchanger upper drum 15a, and a primary coolant liquid surface 5a is filled with a cover gas 33 of argon gas.

As shown in FIG. 2, between the intermediate heat exchanger upper drum 15a and the upper plug 10, there is disposed a thermal-expansion absorbing unit 46 that absorbs a thermal expansion in an axial (vertical) direction and a radial direction of the intermediate heat exchanger upper drum 15a, and defines a cover gas boundary.

As shown in FIG. 3, the thermal-expansion absorbing unit 46 includes a U-shaped cross section drum 36 having a U-shaped cross section and containing a heat insulating member 35, and a two-layered bellows 37 fixed between the upper plug 10 and the U-shaped cross section drum 36 and absorbing a thermal expansion of the intermediate heat exchanger upper drum 15a in the axial direction. One end of the U-shaped cross section drum 36 is attached to the intermediate heat exchanger upper drum 15a, while the other end thereof is attached to the bellows by welding. As described above, one end of the bellows 37 is attached to the U-shaped cross section drum 36 by welding, while the other end thereof is fastened and secured on the upper plug 10 by a bolt 39. Between the upper end of the bellows 37 and the upper plug 10, there is disposed a seal part 38 to define a boundary of a cover gas.

In a case where a vertical length of the intermediate heat exchanger upper drum 15a is sufficiently long, a bending stress applied to the U-shaped cross section drum 36 is relatively lower, when the intermediate heat exchanger upper drum 15a thermally expands in the radial direction. In this case, a cross section of the U-shaped cross section drum 36 may not be U-shaped, but may be semi-polygonal.

A plurality of guides 40 are arranged on an outer circumference of the bellows 37 in order to prevent the bellows 37 from being excessively deformed when the thermal-expansion absorbing unit 46 is disassembled or assembled.

As shown in FIG. 3, between the upper plug 10 and the U-shaped cross section drum 36, there is disposed a convection preventing unit 41 for restraining movement of heat toward the bellows 37 caused by convection of a cover gas. Although the convention preventing unit 41 is disposed outside the U-shaped cross section drum 36, it is possible to dispose the convection preventing unit 41 inside the U-shaped cross section drum 36 as indicated by the reference number 41a.

Between the upper plug 10 and the intermediate heat exchanger upper drum 15a, and between the upper plug 10 and the U-shaped cross section drum 36, there respectively disposed coolant vapor removing units 42 that prevents vapor of the primary coolant 5 from flowing outward from a gap 47. One of the coolant vapor removing units 42 may be omitted.

Next, an operation of this embodiment as described above is described.

At first, a general operation method of the fast reactor 1 is described. In the fast reactor 1, a nuclear fuel containing plutonium is used as the reactor core 2. When the fast reactor 1 is operated, the plutonium of the reactor core 2 undergoes fission to generate heat, and depleted uranium absorbs excessive fast neutron, so that a larger amount of plutonium than an amount of the combusted plutonium is generated. The reflector 4 reflects neutrons radiated from the reactor core 2, so as to promote combustion and breeding of the nuclear fuel of the reactor core 2. In accordance with the combustion of the nuclear fuel, the reflector 4 is gradually moved while maintaining criticality of the nuclear fuel. Thus, a new fuel part of the reactor core 2 is gradually combusted, so that the combustion can continue for a long time.

Next, a concrete operation method of the fast reactor 1 is described. When the fast reactor 1 is operated, the primary coolant 5 of liquid sodium is filled into the reactor vessel 7. The primary coolant 5 cools the reactor core 2, and simultaneously absorbs heat caused by the nuclear fission. Then, the primary coolant 5 that has absorbed the heat generated by the nuclear fission flows through the reactor vessel 7, whereby the heat absorbed by the reactor vessel 7 can be taken outside, which is described below.

That is to say, the sold arrows in FIG. 1 show a flowing direction of the primary coolant 5. As shown by the solid arrows, the primary coolant 5 is driven downward by the solenoid pump 14 to flow through an inside of the neutron shielding member 8 to reach a bottom part of the reactor vessel 7. Then, the primary coolant 5 flows upward through the reactor core 2 to flow into a tube of the intermediate heat exchanger 15 above the reactor vessel 7. Then, the primary coolant 5 flows out the intermediate heat exchanger 15 after the heat is exchanged with the secondary coolant 45. Thereafter, the primary coolant 5 is again driven downward by the solenoid pump 15.

During this period, the secondary coolant 45 flows from outside through the inlet nozzle 18 into a shell of the intermediate heat exchanger 15. The secondary coolant 45 is then cooled by the primary coolant 5 in the intermediate heat exchanger 15, and thereafter flows outward through the outlet nozzle 19 to convert the heat to power.

As described above, a temperature of the lower surface 10b of the upper plug 10 reaches about 500° C. during the operation of the fast reactor 1. On the other hand, a temperature of the upper surface 10a of the upper plug 10 is maintained at about 100° C. Thus, a thermal expansion difference in the axial and radial directions of the intermediate heat exchanger upper drum 15a is considerably large between an area near the upper surface 10a of the upper plug 10 and an area near the lower surface 10b of the upper plug 10. In this case, the thermal expansion in the axial and radial directions of the intermediate heat exchanger upper drum 15a is absorbed by the thermal-expansion absorbing unit 46. Namely, radial deformation of the U-shaped cross section drum 36 of the thermal-expansion absorbing means 46 absorbs the radial thermal expansion of the intermediate heat exchanger upper drum 15a, while axial deformation of the bellows 37 of the thermal-expansion absorbing unit 46 absorbs the axial thermal expansion of the intermediate heat exchanger upper drum 15a.

Meanwhile, the convection preventing unit 41 restrains movement of heat toward the bellows 37 caused by convection of the cover gas 33. The heat insulating member 35 disposed inside the U-shaped cross section drum 36 restrains movement of heat toward the bellows 17 caused by conduction of heat. Further, the coolant vapor removing units 42 prevent vapor of the primary coolant 5 from leaking outside to adhere from the gap formed by the upper plug 10, the intermediate heat exchanger upper drum 15a, and the U-shaped cross section drum 36.

As described above, according to this embodiment, since the U-shaped cross section drum 36 of the thermal-expansion absorbing unit 46 absorbs a thermal expansion of the intermediate heat exchanger upper drum 15a in the radial direction, no excessive load is applied to the structural elements such as the intermediate heat exchanger upper drum 15a or the like. Thus, a structural reliability of the fast reactor can be improved, and a safety thereof can be made excellent.

According to this embodiment, the upper plug 10 is secured on the reactor pedestal 28 via the upper-plug supporting table 32 that directly supports a weight of the upper plug 10. In the present application, since the upper plug 10 is independently supported form equipments of a reactor primary cooling system, variation of a height position of the upper plug 10 can be restrained upon change of operation conditions of the fast reactor 1. Thus, it can be prevented that a height position of the reflector driving apparatus 12 placed on the upper surface 10a of the upper plug 10 is displaced to give an impact on an output of the fast reactor 1.

In addition, according to this embodiment, since the bellows 37 of the thermal-expansion absorbing unit 46 absorbs a thermal expansion of the intermediate heat exchanger upper drum 15a in the axial direction, it can be prevented that a height position of the reflector driving apparatus 12 is displaced to give an impact on an output of the fast reactor 1. Thus, a structural reliability of the fast reactor can be improved, and a safety thereof can be made excellent.

In addition, according to this embodiment, since the convection preventing unit 41 is disposed between the upper plug 10 and the U-shaped cross section drum 36, it is possible to restrain movement of heat toward the bellows 37 caused by convection of the cover gas 33, whereby a temperature of the bellows 37 can be lowered.

In addition, according to this embodiment, since the heat-insulating member 35 is disposed inside the U-shaped cross section drum 36, it is possible to restrain movement of heat toward the bellows 37 caused by conduction of heat, whereby a temperature of the bellows 37 can be lowered.

In addition, according to this embodiment, since there are disposed the coolant vapor removing units 42 for preventing vapor of the primary coolant 5 from flowing outside from the gap 47 formed by the upper plug 10, the intermediate heat exchanger upper drum 15a, and the U-shaped cross section drum 36, it can be prevented that a temperature of the gap 47 is lowered after the vapor of the primary coolant 5 comes thereinto, so that the primary coolant 5 is solidified. Thus, it can be prevented that the upper plug 10 and the intermediate heat exchanger upper drum 15a or the U-shaped cross section drum 36 are adhered to each other, making impossible disassembly.

### Second Embodiment

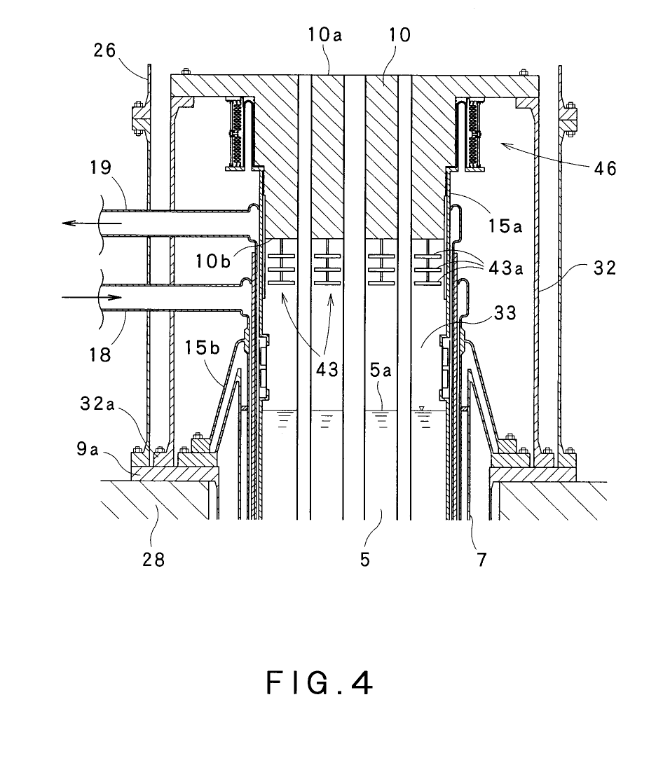

Next, a second embodiment of the present invention is described with reference to FIG. 4.

FIG. 4 is a vertical sectional view of a second embodiment of the present invention.

The second embodiment shown in FIG. 2 differs from the first embodiment as to provision of a radiation and convention prevention plate 43. Other structures and effects of the second embodiment are the same as those of the first embodiment. In FIG. 4, the same parts as those of the first embodiment are shown by the same reference numbers, and their detailed description is omitted.

A general structure of the fast reactor in this embodiment is described with reference to FIG. 4.

As shown in FIG. 4, a radiation and convection preventing plate 43 is attached to a lower surface 10b of an upper plug 10 of a fast reactor 1. The radiation and convection preventing plate 43 is formed by stacking a plurality of metal plates with a certain gap therebetween. The radiation and convection preventing plate 43 is hung from the lower surface 10b of the upper plug 10 to float in a cover gas 33. The radiation and convection preventing plate 43 restrains radiation and convection of heat in a space formed by the upper plug 10, an intermediate heat exchanger upper drum 15a, and a primary coolant liquid surface 5a.

According to this embodiment, since the radiation and convection preventing plate 43 is attached to the lower surface 10b of the upper plug 10, radiation and convection of heat from the primary coolant liquid surface 5a can be restrained. Thus, heat input to the upper plug 10 can be reduced.

1. A fast reactor comprising:
a reactor vessel accommodating therein a reactor core and a primary coolant;
an intermediate heat exchanger disposed in the reactor vessel, for transferring a heat energy of the primary coolant heated in the reactor core to a secondary coolant;
an intermediate heat exchanger upper drum disposed above the intermediate heat exchanger;
an upper plug disposed above the intermediate heat exchanger upper drum, and having a neutron shielding function and a heat shielding function; and
a thermal-expansion absorbing unit disposed between the intermediate heat exchanger upper drum and the upper plug, for absorbing a thermal expansion of the intermediate heat exchanger upper drum in an axial direction and a radial direction of the intermediate heat exchanger upper drum, and defining a reactor cover gas boundary.

2. The fast reactor according to claim 1, wherein
the upper plug is secured on a reactor pedestal via an upper-plug supporting unit that directly supports a weight of the upper plug.

3. The fast reactor according to claim 1, wherein
the thermal-expansion absorbing unit includes a U-shaped cross section drum that is attached to the intermediate heat exchanger upper drum and has a U-shaped cross section.

4. The fast reactor according to claim 3, wherein
the thermal-expansion absorbing unit further includes a bellows that is attached to the upper plug and absorbs a thermal expansion of the intermediate heat exchanger upper drum in the axial direction, and
the U-shaped cross section drum has one end attached to the intermediate heat exchanger upper drum, and the other end thereof attached to the bellows.

5. The fast reactor according to claim 4, wherein
a convection preventing unit is disposed between the upper plug and the U-shaped cross section drum, for restraining movement of heat caused by convection of a cover gas.

6. The fast reactor according to claim 3, wherein
an inside of the U-shaped cross section drum is filled with a heat insulating member.

7. The fast reactor according to claim 4, wherein
one of the upper plug, the intermediate heat exchanger upper drum, and the U-shaped cross section drum has a coolant vapor removing unit for preventing vapor of the primary coolant from flowing outward from a gap formed by the upper plug, the intermediate heat exchanger upper drum, and the U-shaped cross section drum.

8. The fast reactor according to claim 1, wherein
a radiation and convection preventing plate is attached to a lower surface of the upper plug, and
the radiation and convection preventing plate restrains radiation and convection of heat in a space formed by the upper plug, the intermediate heat exchanger upper drum, and a primary coolant liquid surface.
